(19) United States
(12) Patent Application Publication
(10) Pub. No.: US 2003/0046406 A1
(43) Pub. Date: Mar. 6, 2003

(54) HTTP connector

(75) Inventors: Michael Beisiegel, Poughkeepsie, NY (US); Jean-Sebastien M. Delfino, Toronto (CA); Piotr Przybylski, Brooklin (CA)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY

(21) Appl. No.: 10/229,511

(22) Filed: Aug. 28, 2002

(30) Foreign Application Priority Data
Aug. 29, 2001 (CA) 2,356,018

(51) Int. Cl. G06F 15/16

(52) U.S. Cl. 709/228

(57) ABSTRACT

The present invention provides an HTTP connector implementation to be used by disparate computer systems to communicate with each other over the World Wide Web. In particular, the present invention is directed to business to business communications and meets the specifications of the J2EE Connector Architecture. The present invention provides an HTTP interface that may easily be adapted by existing applications while at the same time shielding the developer from the low level details of the HTTP.

### BACKGROUND OF THE INVENTION

1. Field of the Invention

The present invention relates generally to the field of connecting computer systems by a common communication interface. More particularly, the present invention provides a generic HTTP interface that may be utilized by a variety of different computer systems.

2. Description of the Related Art

In traditional computing architecture, when it was necessary for disparate computer systems to communicate with each other, developers would produce a layer of software or hardware known as “middleware”. This middleware would translate communication protocols (i.e. ways of communicating) so that one system could exchange data with another. For example, a program running on an International Business Machines mainframe needing to extract data from Digital Equipment Corporation database server would make use of middleware as a standard interface. Over time, the use of such interfaces, known as Application Programming Interfaces (APIs) proliferated. Each with its own special syntax and interface. For networked systems that included a variety of different types of hardware and software interfaces. This quickly became an issue for software development. Most organizations simply do not have the resources to maintain a plurality of different interfaces between the machines their software products need to communicate with.

To address this problem, IBM Canada Ltd. filed a patent application in Canada, namely patent application number 2,248,634 (the '634 application) which was published on Mar. 24, 2000. The '634 application discloses a framework to allow an application program running on one system to communicate through a standardized communication protocol with a backend running on another system. In our previous example, the IBM mainframe would be running the application, and the DEC database would be the backend application.

Currently, the most ubiquitous computing network is the Internet. A significant portion of the Internet makes use of the Hypertext Transfer Protocol (HTTP), this is the protocol recognized by web browsers such as Netscape and Internet Explorer and is utilized by web pages on the World Wide Web (WWW). As the use of the WWW increases, the use of HTTP increases as well. In particular, HTTP has become a protocol of choice for the exchange of data between business enterprises connected to the Internet.

A wide variety of HTTP implementations exist, all of which are very specific. In essence they provide a specific API interface as discussed above. Because of this, existing applications would need to be changed to adapt to each different HTTP implementation.

Thus, there is a need for a seamless, open and flexible HTTP interface that shields an application from the protocol details and allows existing applications to easily function with a variety of HTTP implementations.

### SUMMARY OF THE INVENTION

The present invention relates to a method and system for utilizing an HTTP connector implementation to allow computer systems to communicate using a generic HTTP interface.

One aspect of the present invention is a system for communicating with one or more target systems by using an HTTP connector, the system having an infrastructure, an application component and an HTTP connector, the application component connected to the HTTP connector via a client view, the HTTP connector connected to the infrastructure by an infrastructure view, and the HTTP connector connected to the one or more target systems for the purpose of exchanging data with the one or more target systems.

In another aspect of the present invention, there is provided an HTTP connector method, the method having the steps of: requesting a connection to a target system, using an HTTP connector; determining if the connection to the target system has been established, if not, terminating the method; determining the type of interaction desired with the target system and acting upon the type; and returning control to the requesting step.

In another aspect of the present invention there is provided a system for establishing an HTTP connection, the system comprising: request means for establishing a connection to a target system, using a HTTP connector; testing means to determine if the connection to the target system has been established; selection means for determining the type of interaction desired with the target system; and communication means for communicating with the target system in a manner based upon the type of interaction.

In another aspect of the present invention there is provided a J2EE Connector Architecture compliant connector, the connector comprising the classes: HTTPConnection, HttpConnectionFactory, HttpConnectionMetaData, HttpConnectionRequestInfo, HttpConnectionSpec, HttpContentRecord, HttpInteraction, HttpInteractionSpec, HttpManagedConnection, HttpManagedConnectionFactory, HttpManagedConnectionMetaData, and HttpResourceAdapterMetaData.

In another aspect of the present invention there is provided a computer readable medium containing instructions for implementing an HTTP connector method, the instructions comprising the steps of: requesting a connection to a target system, using HTTP; determining if the connection to the target system has been established, if not, terminating the method; determining the type of interaction desired with the target system and acting upon the type; and returning control to the requested step.

In yet another aspect of the present invention there is provided a computer readable medium containing instructions for creating a J2EE Connector Architecture compliant connector, said instructions comprising the classes: HTTPConnection, HttpConnectionFactory, HttpConnectionMetaData, HttpConnectionRequestInfo, HttpConnectionSpec, HttpContentRecord, HttpInteraction, HttpInteractionSpec, HttpManagedConnection, HttpManagedConnectionFactory, HttpManagedConnectionMetaData, and HttpResourceAdapterMetaData.

### BRIEF DESCRIPTION OF THE DRAWINGS

For a better understanding of the present invention, and to show more clearly how it may be carried into effect, reference will now be made, by way of example, to the accompanying drawings which aid in understanding an embodiment of the present invention and in which:

FIG. 1 is a block diagram of a system utilizing the present invention; and

FIGS. 2a to 2c comprise a flowchart illustrating the logical flow of an embodiment of the present invention.

### DESCRIPTION OF THE PREFERRED EMBODIMENTS

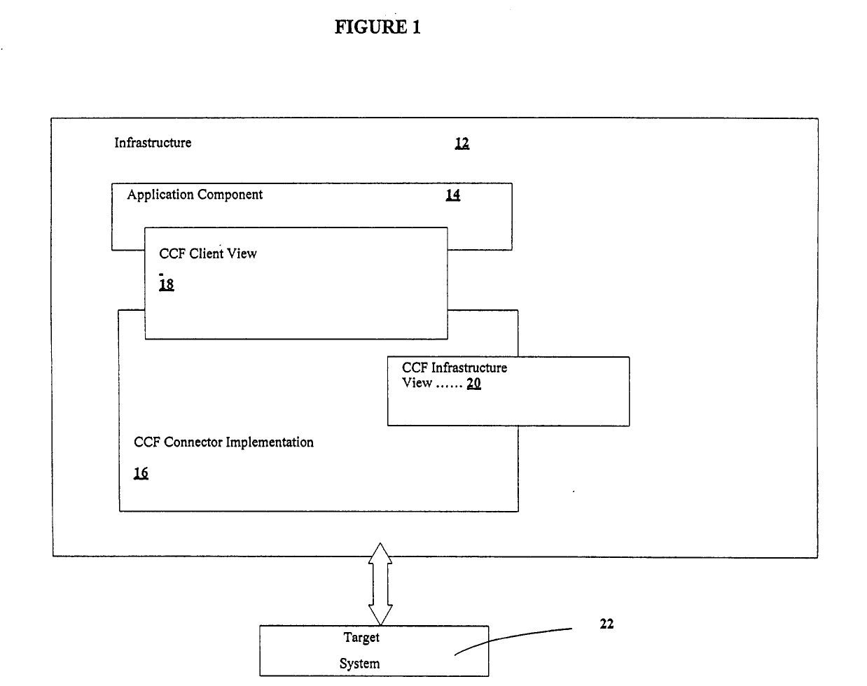

To aid the reader in understanding the architecture in which the present invention may be implemented we now refer to FIG. 1. FIG. 1 is a block diagram of a system utilizing the present invention, shown as 10.

System 10 comprises: infrastructure 12, application component 14, CCF connector 16, CCF client view 18 and CCF infrastructure view 20. Infrastructure 12 is the computer system on which the present invention runs and all the services to which system 10 has access. Application component 14 is a client application running within infrastructure 10. CCF connector 16 is an interface which allows component 14 to communicate with one or more target systems 22. Specific to the present invention, component 14 would be communicating with target system 22 to obtain data via an HTTP connection. Connector 16 is the portion of system 10 in which the present invention resides. More specifically the present invention is a connector 16 that provides an HTTP interface. Client view 18 allows application 14 to use well defined and consistent interfaces with a plurality of target systems 22, via connector 16. CCF infrastructure view 20 provides an interface between CCF connector 16 and infrastructure 12 so that connector 16 may access such services as error handling, trace logging, security controls or remote access services (RAS).

The implementation of the present invention follows the specification described in the Java 2 Enterprise Edition (J2EE) Connector Architecture, Proposed Final Draft 2 document. The J2EE specification provides a distributed services-based architecture for implementing electronic business applications. The present invention is a non-transactional connector that implements HTTP communication protocol version 1.0 as specified in Request for Comments (RFC) 1945. Most computer software standardization processes involve the publication of RFC's to which those interested reply and provide suggestions.

The present invention has been implemented in Java and as such the description of the preferred embodiment will be Java based. It will be appreciated by those skilled in the art that the use of Java facilitates the description and implementation of the preferred embodiment. However, the preferred embodiment can be adapted to other computer languages. Similarly, the preferred embodiment need not run in the architecture described in FIG. 1, as one skilled in the art will recognize any number of system architectures may make use of the present invention.

In the preferred embodiment, the present invention consists of the following classes:

1) HttpConnection

2) HttpConnectionFactory

3) HttpConnectionMetaData

4) HttpConnectionRequestInfo

5) HttpConnectionSpec

6) HttpContentRecord

7) HttpInteraction

8) HttpInteractionSpec

9) HttpManagedConnection

10) HttpManagedConnectionFactory

11) HttpManagedConnectionMetaData

12) HttpResourceAdapterMetaData

We will now discuss the functionality of each of these classes.

1) HttpConnection

The following is a list of methods and their signatures implemented by the HttpConnection class:

HttpConnection(ManagedConnection)

void call(Interaction, InteractionSpec, Record, Record)

void close( )

Interaction createInteraction( )

boolean getAutoCommit( )

LocalTransaction getLocalTransaction( )

HttpManagedConnection getManaged( )

ConnectionMetaData getMetaData( )

ResultSetInfo getResultSetInfo( )

void logTrace(String)

void setAutoCommit(boolean)

void setLogWriter(PrintWriter)

void setManaged(HttpManagedConnection)

This class represents an application handle to a physical connection. It is created by HttpConnectionFactory and is associated with a particular HttpManagedConnection instance through which the communication With a target system 22 is executed. HttpConnection creates HttpInteraction objects, by the createInteraction method. Since the present invention does not support transactional behaviour, HttpConnection throws a javax.resource.NotSupportedException from the following methods:

setAutoCommit(boolean)

getLocalTransaction( )

getAutoCommit( )

HttpConnection also throws a NotSupportedException from the getResultSetInfo( ) method. The close request (in the close( ) method implementation) passes the close request to the associated HttpManagedConnection. HttpConnection handles interaction requests, from the HttpInteracton objects it created, in the call( . . . ) method, implemented in addition to the required interface methods. In this method, HttpConnection passes the execution request, along with its instance to the associated HttpManagedConnection.

2) HttpConnectionFactory

The following is a list of methods and their signatures implemented by the HttpConnectionFactory class.

HttpConnectionFactory( )

HttpConnectionFactory(ConnectionManager)

Connection getConnection( )

Connection getConnection(ConnectionSpec)

ManagedConnectionFactory getManagedConnectionFactory( )

ResourceAdapterMetaData getMetaData( )

RecordFactory getRecordFactory( )

Reference getReference( )

void logTrace(String)

void setConnectionManager(ConnectionManager)

void setManagedConnectionFactory(ManagedConnectionFactory)

void setReference(Reference)

The HttpConnectionFactory class represents objects capable of creating active HttpConnections. It is instantiated by and maintains association with the instance of the HttpManagedConnectionFactory. It also contains the instance of the ConnectionManager class which it uses to obtain connections during the connection request, in the getConnection( ) method implementation. If the new connection is requested passing the ConnectionSpec object (getConnection( ) method with the argument), the HttpConnectionFactory verifies that the passed object is an instance of the HttpConnectionSpec, then creates the new instance of the HttpConnectionRequestInfo object, sets its properties using values from the ConnectionSpec and then invokes the allocateConnection method of its associated ConnectionManager instance. HttpConnectionFactory also stores the Referenceable object, providing its accessors in support for factory creation in the server environment. HttpConnectionFactory also stores the instance of the Referenceable object, with accessor methods to support factory creation in the managed environment

3) HttpConnectionMetaData

The following is a list of methods and their signatures implemented by the HttpConnectionMetaData class.

HttpConnectionMetaData(HttpConnection)

String getEISProductName( )

String getEISProductVersion( )

String getUserName( )

HttpConnectionMetaData is an object storing the connection information. It contains accessor methods to retrieve the following information:

EISProductName

EISProductVersion

UserName

4) HttpConnectionRequestInfo

The following is a list of methods and their signatures implemented by the HttpConnectionRequestInfo class.

boolean equals(Object)

String getPassword( )

String getUserName( )

int hashCode( )

void setPassword(String)

void setUserName(String)

HttpConnectionRequestInfo is a class containing the connection specific information that does not change the characteristics of the HttpManagedConnection i.e. the same instance of the HttpManagedConnection can be used to create HttpConnection instances with different HttpConnectionRequestInfo. HttpConnectionRequestInfo contains user name and password properties and implements hashCode and equals methods using these properties to calculate hash value and compare two instances for equality, respectively.

5) HttpConnectionSpec

The following is a list of methods and their signatures implemented by the HttpConnectionSpec class.

boolean equals(Object)

String getPassword( )

String getUserName( )

int hashCode( )

void setPassword(String)

void setUserName(String)

HttpConnectionSpec represents the application level access to the connection specific information corresponding to the information contained in HttpConnectionRequestInfo. During the servicing of a connection request (getConnection( ) method implementation), HftpConnectionFactory copies values from HttpConnectionSpec to HttpConnectionRequestInfo. HttpConnectionSpec contains user name and password properties and implements hashCode and equals method that use these properties to calculate hash value and compare two instances for equality respectively.

6) HttpContentRecord

The following is a list of methods and their signatures implemented by the HttpContentRecord class.

Object clone( )

String getRecordName( )

String getRecordShortDescription( )

void read(InputStream)

void setRecordName(String)

void setRecordShortDescription(String)

void write(OutputStream)

HttpContentRecord is a class implementing javax.resource.cci.Record and javax.resource.cci.Streamable interfaces from the J2EE specification. It represents the data object passed to the execute method of the HttpInteraction class and containing the information received from target system 22. The present invention uses this object internally to handle requests of the execution from applications that do not provide the output record i.e. invoke the execute( . . . ) method in HttpInteraction with only an input record argument.

7) HttpInteraction

The following is a list of methods and their signatures implemented by the HttpInteraction class.

HttpInteraction(Connection)

void clearWarnings( )

void close( )

Record execute(InteractionSpec, Record)

boolean execute(InteractionSpec, Record, Record)

Connection getConnection( )

RecordFactory getRecordFactory( )

ResourceWarning getWarnings( )

void logTrace(String)

void setLogWriter(PrintWriter)

HttpInteraction represents objects used by an application 14 to perform interaction with target system 22 through the use of the present invention. A HttpInteraction object is created by HttpConnection and HttpConnection maintains a reference to the created object. The execution request, implemented through either of the execute methods of HttpInteraction is passed to the associated HttpConnection instance for further processing through the invocation of the protected call method and passing the arguments of the execute method, HttpInteractionSpec, input record and output record. If the execute method with only input record was invoked, HttpInteraction creates a new instance of the HttpContentRecord and passes it to the call method as the output record. Since HttpInteraction does not maintain any state, the implementation of the close method does not perform any operation except verifying that it is not in an already closed state. If it is, i.e. the close method had been previously invoked, the method throws javax.resource.spi.IllegalStateExcepton. This exception is also thrown if one of the execute methods is invoked when the HttpInteraction has been closed.

8) HttpInteractionSpec

The following is a list of methods and their signatures implemented by the HttpInteractionSpec class.

HttpInteractionSpec( )

String getContentType( )

Hashtable getHeaderFields( )

int getInteractionVerb( )

void setContentType(String)

void setHeaderFields(Hashtable)

void setInteractionVerb(int)

The HttpInteractionSpec class implements interaction specific properties of the present invention. These properties include the interaction mode (mapped to the appropriate request method in the HttpManagedConnection), a value indicating one of the following interaction types:

a) synchronous send and receive—the request is sent through connector 16 to target system 22 and the reply is passed back to the invoking application 14;

b) synchronous send—the data is sent to target system 22; and

c) synchronous receive—the data is received from target system 22.

These values are referred to in the J2EE Connector Architecture as: SYNC_SEND_RECEIVE, SYNC_SEND and SYNC_RECEIVE. In the interest of readability in the figures and the specification, we refer to these values as: “send_receive”, “send”, and “receive” respectively.

Another property characterizing the interaction that can be specified on the HttpInteractionSpec are request headers. An application 14 using the present invention through connector 16 provides these as a hash table of keys and values. The class implementation also provides direct accessors to the contents type of the request, which is then automatically written as one of the http headers with the key “Content-Type”.

9) HttpManagedConnection

The following is a list of methods and their signatures implemented by the HttpManagedConnection class.

HttpManagedConnection(Subject, ConnectionRequestInfo, String)

void addConnectionEventListener(ConnectionEventListener)

void associateConnection(Object)

void call(HttpConnection, InteractionSpec, Record, Record)

void cleanup( )

void close(HttpConnection)

void destroy( )

void errorOccurred(Exception)

Object getConnection(Subject, ConnectionRequestInfo)

LocalTransaction getLocalTransaction( )

PrintWriter getLogWriter( )

ManagedConnectionMetaData getMetaData( )

Subject getSecurityContext( )

String getUserName( )

XAResource getXAResource( )

boolean isDirty( )

void logTrace(String)

void receive(Streamable, InputStream)

void removeConnectionEventListener(ConnectionEventListener)

void send(Streamable, OutputStream)

void setDirty(boolean)

void setLogWriter(PrintWriter)

HttpManagedConnection is the class representing the HTTP protocol physical connection to target system 22, specified through a URL. The application level access to the connection is provided through the application level handles HttpConnection which it can instantiate. HttpManagedConnection supports multiple handles, however only the most recently created handle can be used to perform interactions. The access from any other handle, before the last handle created issues close notification, is treated as an error and causes an IllegalStateException to be thrown. The validation and current handle maintenance is implemented through storing handles in a stack data structure with the valid handle at the top. The stack data structure is internal to the class implementation, and is not exposed outside the class and only used by its methods. Each access from the HttpConnection is validated against this data structure and the appropriate action is taken. The main methods implemented by the Http ManagedConnection class as are follows:

a) void associateConnection(Object)—in this method, the passed HttpConnection object is disassociated from its current HttpManagedConnection, using the close method invocation and then associated with the managed connection as the most recent application level handle on top of the handles stack.

b) void call(HttpConnection, InteractionSpec, Record, Record)—this method is used by HttpConnection to pass an execution request. HttpManagedConnection first verifies that the request has a valid handle passed as an argument and that the passed InteractionSpec object is the instance of the HttpInteractionSpec. Next, it creates a connected HttpURLConnection to the target system 22 URL using standard java.net library method invocation URL.openConnection( ). After the HttpURLConnection is created, the headers set on the HttpInteractionSpec are set on the HttpURLConnection as request properties the next action depends on the InteractionVerb property specified in HttpInteractionSpec. For send_receive the HttpURLConnection request method is set to “POST” and both doInput and doOutput properties of HttpURLConnection are set to true. For the send, the request method is set to PUT, doOutput to true and dolnput to false, and finally, for the receive, the request method is set to GET, doOutput to false and doInput to true.

An input record is a record that is sent to target system 22. Application 14 fills the input record with request data and sends it to the target 22 via connector 16. Thus, it is input data to target system 22. Similarly, an output record contains data output from target system 22 which is provided to application 14.

At the next step, the HttpURLConnection is connected and then the contents of the input record (extracted by viewing record as an implementation of the Streamable interface) is written to its output stream For send_receive and send and/or the content of the output record is read from the HttpURLConnection input stream for the send_receive and receive. Next, the headers returned by the HttpURLConnection are copied to the hash table and set in the HttpInteractionSpec to be returned to the application. The last step in the method is disconnecting the HttpURLConnection. If, during its execution the call method encounters a communication error, it sets an ERROR_OCCURRED event and then throws a CommException to the invoker.

c) void cleanup( ) this method cleans up the internal state of the HttpManagedConnection by emptying the handles stack.

d) void close(HttpConnection)—this method is invoked to forward an application close request on the connection handle. The HttpManagedConnection removes the handle that invoked the method from the top of the stack and sets a CONNECTION_CLOSED event.

e) void destroy( )—this method permanently cleans up the internal state of the HttpManagedConnection by emptying and deallocating the handles stack and setting the HttpURLConnection to null.

f) Object getConnection(Subject, ConnectionRequestInfo)—in this method, new connection handle is created and put on the top of the handles stack.

Since the HTTP Connector does not support transactional behaviour, i.e. the ability to roll back units of work, the methods getXARespirce( ) and getLocalTransaction( ) throw the NotSupportedException.

10) HttpManagedConnectionFactory

The following is a list of methods and their signatures implemented by the HttpManagedConnectionFactory class.

Object createConnectionFactory( )

Object createConnectionFactory(ConnectionManager)

ManagedConnection

createManagedConnection(Subject, connectionRequestInfo)

boolean equals(Object)

PrintWriter getLogWriter( )

String getURL( )

int hashCode( )

void logTrace(String)

ManagedConnection

matchManagedConnections(Set, Subject, ConnectionRequestInfo)

void setLogWriter(PrintWrter)

void setURL(String)

The HttpManagedConnectionFactory class instance creates HttpManagedConnection objects. Each created object is passed the connection URL of the target system 22 and the logWriter properties of the factory. The logWriter is a class (PrintWriter to be exact) which is used by the HttpManagedConnectionFactory to record its trace and error information. When it is set on the HttpManagedConnectionFactory, the J2EE specification Connector architecture specification, requires it to pass the instance to every managed connection it creates.

11) HttpManagedConnnectionMetaData

The following is a list of methods and their signatures implemented by the HttpManagedConnectionMetaData class.

HttpManagedConnectionMetaData(HttpManagedConnection)

String getEISProductName( )

String getEISProductVersion( )

int getMaxConnections( )

String getUserName( )

HttpManagedConnectionMetaData provides information about the connector 16 such as target system 22 product and version, maximum number of connections supported by the target system 22 and the name of the user.

12) HttpResourceAdapterMetaData

The following is a list of methods and their signatures implemented by the HttpResourceAdapterMetaData class.

String getAdapterName( )

String getAdapterShortDescription( )

String getAdapterVendorName( )

String getAdapterVersion( )

String [] getInteractionSpecsSupported( )

String getSpecVersion( )

boolean supportsExecuteWithInputAndOutputRecord( )

boolean supportsExecuteWithInputRecordOnly( )

boolean supportsLocalTransactionDemarcation( )

HttpResourceAdapterMetaData provides an application 14 with the characteristics of the resource adapter terms such as name, description, vendor name, adapter version and specification version supported. It also contains information describing which optional features of the specification have been implemented, such as names of InteractionSpec implementation classes, which type of execute method connectors are supported and whether it supports local transactions. Here we use the term “resource adapter” as it is the terminology utilized by the J2EE. Connector architecture specification. For the purposes of the present specification and claims, the terms “resource adapter” and “connector” (i.e. connector 16), are interchangeable

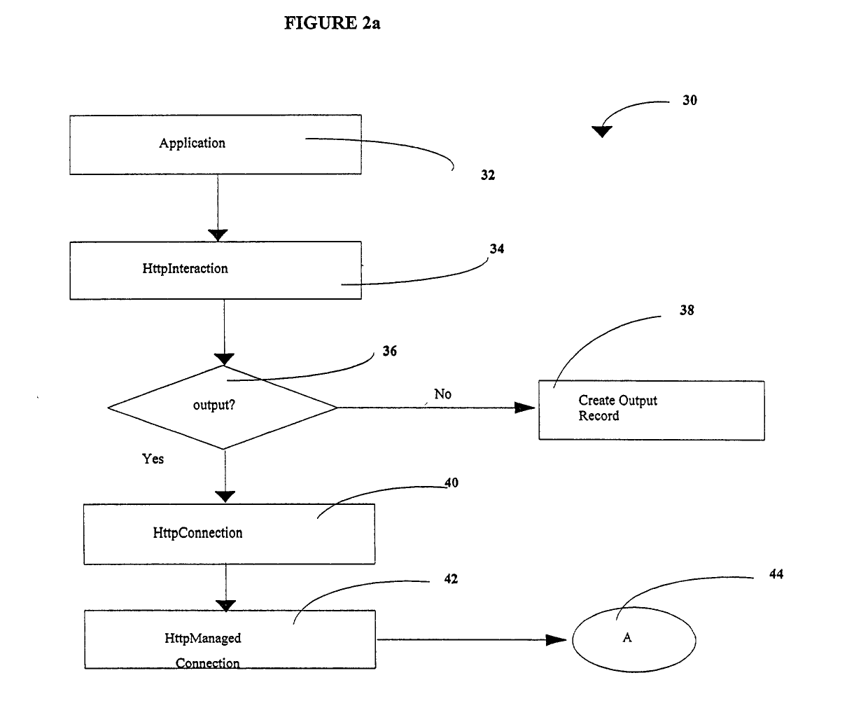

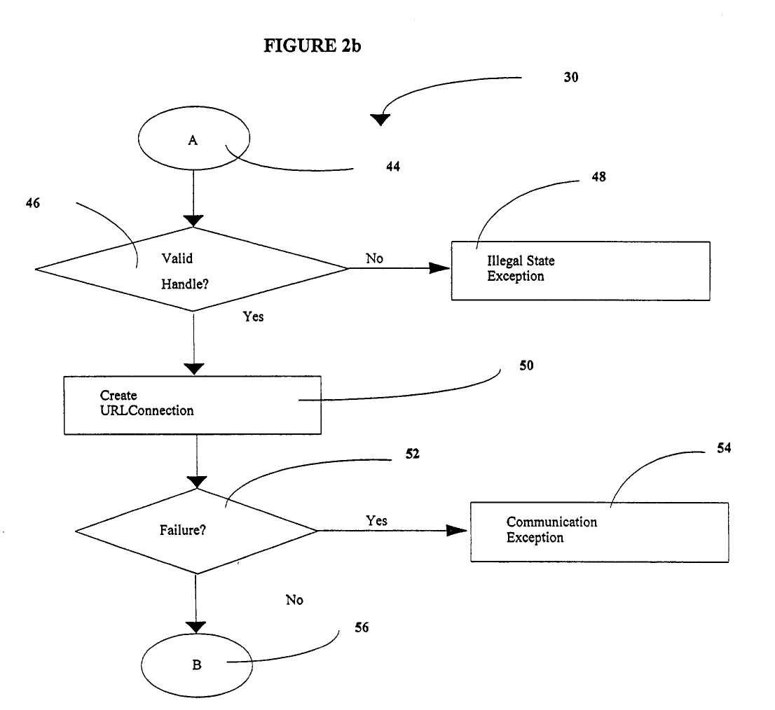

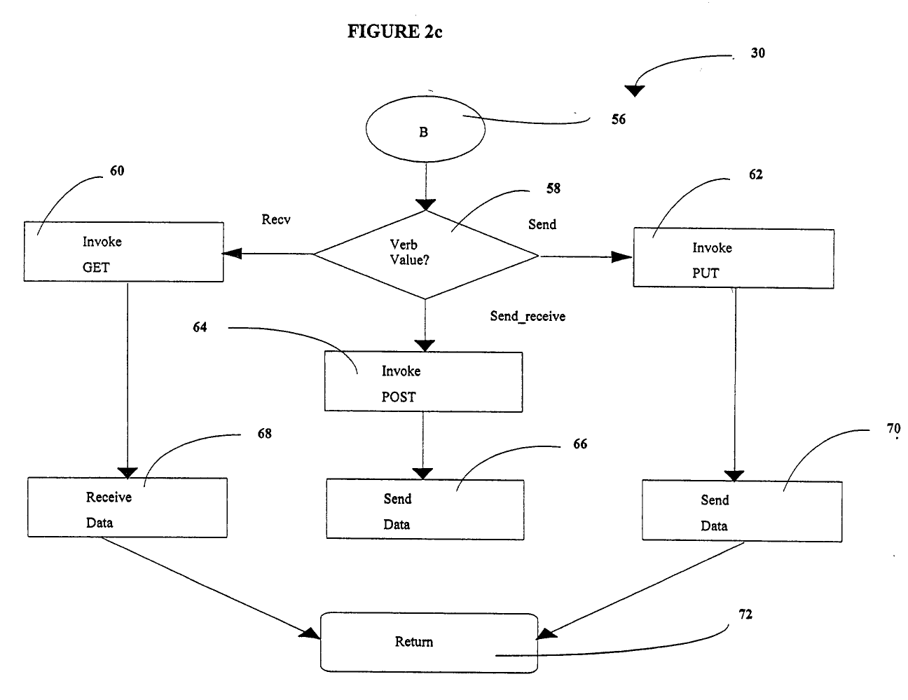

To illustrate how the above described classes implement the present invention, we refer now to FIGS. 2a to 2c which are a series of flowcharts illustrating the process of an embodiment of the present invention. The process is shown generally as 30.

Referring first to FIG. 2a, beginning at step 32 an application 14 (see FIG. 1), requests a connection to a target system 22 using the HTTP protocol by invoking: execute(HttpInteractionSpec,inputRecord,outputRecord) of class HttpInteraction at step 34. At step 36 if an outputRecord was not specified, then one is created at step 38. At step 40 the call method of class HttpConnection is invoked by: call(HttpInteraction, HttpInteractionSpec, inputRecord, outputRecord). At step 42 the call method of class HttpManagedConnection is invoked by: call(HttpConnection, HttpInteractionSpec, inputRecord, outputRecord). Block 44 serves as a transfer to FIG. 2b.

Referring now to FIG. 2b, at step 46 if the current handle (i.e. the instance of HttpConnection) is not the most current, an IllegalStateException is thrown at step 48 and process 30 terminates. Should the current handle be valid, process 30 moves to step 50 where a connection with target system 22 is made by invoking URL.openConnection( ) of the standard java.net library. At step 52 it is determined if a valid connection has been established. If a valid connection has not been established, control moves to step 54 where a CommException is thrown and process 30 ends. If a valid connection has been established, then process 30 continues. Block 56 serves as a transfer to FIG. 2c.

Referring now to FIG. 2c, at step 58 the value of the InteractionVerb contained within the HttpInteraction instance is examined. The value of InteractionVerb may be one of: receive, send, or send_receive. For each value one of the following steps are taken:

a) For receive, at step 60 requestMethod of HttpURLConnection is set to GET, dolnput is set to true and doOutput is set to false. Data is then received from the target system 22 at step 68 and provided to application 14.

b) For send, at step 62 HttpURLConnection request method is set to PUT, doInput is set to false and dooutput is set to true. Data is then sent to the target system 22 at step 70.

c) For send_receive, at step 64 HttpURLConnection request method is set to POST, doInput is set to true and doOutput is set to true. Properties of the HttpURLConnection data is next sent from application 14 to the target system 22 at step 66 and then data is received for application 14 from the target system 22 at step 68.

At step 72 process 30 ends and control is returned to application 14.

Although the above disclosure mentions the Internet or WWW as an example of a network on which the present invention may be utilized, it is not the intent of the inventors to exclude Intranets, Extranets, or any form of network using an HTTP protocol, including but not limited to: wireless, twisted pair, cable and satellite. In a special case, connector 16 and target system 22 may reside on the same system 10. Similarly System 10 may be any computing device capable of supporting the present invention, including but not limited to: standalone computer systems, handheld devices and television settop boxes.

Although the invention has been described with reference to certain specific embodiments, various modifications thereof will be apparent to those skilled in the art without departing from the spirit and scope of the invention as outlined in the claims appended hereto.

We claim:

1. A system for communicating with one or more target systems by using an HTTP connector, said system comprising:
an infrastructure; and
an application component and an HTTP connector, said application component connected to said HTTP connector via a client view, said HTTP connector connected to said infrastructure by an infrastructure view, and said HTTP connector connected to said one or more target systems for the purpose of exchanging data with said one or more target systems.

2. The system of claim 1, wherein said communicating with one or more target systems is conducted over the internet.

3. An HTTP connector method, said method comprising the steps of
a) requesting a connection to a target system, using a HTTP connector;
b) determining if said connection to said target system has been established, and, if not, terminating said method;
c) determining a type of interaction desired with said target system and acting upon said type; and
d) returning control to step a).

4. The method of claim 3, wherein if at said step c) said type of interaction has a value of receive, then receiving data from said target system.

5. The method of claim 3, wherein if at said step c) said type of interaction has a value of send, then sending data to said target system.

6. The method of claim 3, wherein if at said step c) said type of interaction has a value of send_receive, first sending data to said target system then receiving data from said target system.

7. The method of claim 3, wherein said step a) further comprises creating an output record if one has not been created.

8. The method of claim 7, wherein said step a) further comprises throwing an illegal state exception if a valid handle has not been used in requesting said connection.

9. The method of claim 3, wherein said step b) further comprises throwing a communication exception if said connection has not been established.

10. A system for establishing an HTTP connection, said system comprising:
request means for establishing a connection to a target system, using a HTTP connector;
testing means to determine if said connection to said target system has been established;
selection means for determining a type of interaction desired with said target system; and
communication means for communicating with said target system in a manner based upon said type of interaction.

11. The system of claim 10, wherein if said type of interaction has a value of receive, then said communication means receives data from said target system.

12. The system of claim 10, wherein if said type of interaction has a value of send, then said communication means sends data to said target system.

13. The system of claim 10, wherein if said type of interaction has a value of send_receive, said communication means first sends data to said target system and then receives data from said target system.

14. The system of claim 10, further comprising output record creation means if an output record has not been created by said request means.

15. The system of claim 14, further comprising illegal state exception means for throwing an illegal state exception should a valid handle not be used in requesting a connection to said target system.

16. The method of claim 10, wherein said testing means throws a communication exception if communication cannot be established with said target system.

17. A computer readable medium containing instructions for implementing an HTTP connector method, said instructions comprising:
first instructions for requesting a connection to a target system, using HTTP;
second instructions for determining if said connection to said target system has been established, and, if not, terminating said HTTP connector method;
third instructions for determining a type of interaction desired with said target system and acting upon said type; and
fourth instructions for returning control to said first instructions.

18. The medium of claim 17 wherein said third instructions determines that said type of interaction has a value of receive, then data is received from said target system.

19. The medium of claim 17, wherein if said third instructions determines that said type of interaction has a value of send, then data is sent to said target system.

20. The medium of claim 17, wherein if said third instructions determines that said type of interaction has a value of send_receive, data is first sent to said target system then data is received from said target system.

21. The medium of claim 17, wherein said first instructions further comprises creating an output record if one has not been created.

22. The medium of claim 21, wherein said first instructions further comprises throwing an illegal state exception if a valid handle has not been used in requesting said connection.

23. The medium of claim 17, wherein said second instructions further comprises throwing a communication exception if said connection has not been established.
